(19) United States
(12) Patent Application Publication
(10) Pub. No.: US 2019/0109842 A1
(43) Pub. Date: Apr. 11, 2019

(54) SYSTEM AND METHOD FOR REGISTERING AND AUTHORIZING SECONDARY DEVICES FOR CONDUCTING TRANSACTIONS

(71) Applicant: CA, Inc., New York, NY (US)

(72) Inventors: Sharath L. Kumar, Bangalore (IN); Arun Shetty, Bangalore (IN); Badrinath Mohan, Bangalore (IN); Jaimini Ram, Bangalore (IN); Stephen Prasad, Bengaluru (IN)

(73) Assignee: CA, Inc.

(21) Appl. No.: 15/726,587

(22) Filed: Oct. 6, 2017

(51) Int. Cl. H04L 29/06; G06F 21/44; G06Q 30/06; H04W 12/06; H04W 4/02; H04W 4/12

(52) U.S. Cl. CPC H04L 63/0853; G06F 21/44; H04L 63/0838; H04W 4/12; H04W 12/06; H04W 4/02; G06Q 30/06

(57) ABSTRACT

According to an embodiment of the present disclosure, a method by a server includes receiving, by the server, a request to register a computing device for conducting transactions associated with an account. The server determines that a primary computing device is already registered as a first authorized device for conducting transactions associated with the account. A request to authorize the computing device as a second authorized device for conducting transactions associated with the account is transmitted to the primary computing device. Permission to register the computing device as the second authorized device is received from the primary computing device. The computing device is then registered as the second authorized device for conducting transactions associated with the account.

### BACKGROUND

The present disclosure relates to interfaces and, in particular, to a method, apparatus, and executable instructions for registering and authorizing secondary devices for conducting transactions.

### SUMMARY

The present disclosure relates to interfaces and, in particular, to a method, apparatus, for registering and authorizing secondary devices for conducting transactions associated with a primary user's account.

According to an embodiment of the present disclosure, a method by a server includes receiving, by the server, a request to register a computing device for conducting transactions associated with an account. The server determines that a primary computing device is already registered as a first authorized device for conducting transactions associated with the account. A request to authorize the computing device as a second authorized device for conducting transactions associated with the account is transmitted to the primary computing device. Permission to register the computing device as the second authorized device is received from the primary computing device. The computing device is then registered as the second authorized device for conducting transactions associated with the account.

According to another embodiment of the present disclosure, a non-transitory, computer-readable storage medium has instructions stored thereon. The instructions are executable by a computing system to cause the computing system to receive a request to register a mobile computing device for conducting transactions associated with an account. It is determined that a primary mobile computing device is already registered as a first authorized device for conducting transactions associated with the account. A request to authorize the mobile computing device as a second authorized device for conducting transactions associated with the account is transmitted to the primary mobile computing device. Permission to register the mobile computing device as the second authorized device is received from the primary mobile computing device. The mobile computing device is then registered as the second authorized device for conducting transactions associated with the account.

According to another embodiment of the present disclosure, a server includes a memory storing account information for a plurality of accounts and processing circuitry with access to the memory. The processing circuitry is configured to receive a request to register a secondary computing device for conducting transactions associated with an account. The processing circuitry determines that a primary computing device is already registered as a first authorized device for conducting transactions associated with the account. A request to authorize the secondary computing device as a second authorized device for conducting transactions associated with the account is transmitted to the primary computing device. Permission to register the secondary computing device as the second authorized device is received from the primary computing device. The secondary computing device is registered as the second authorized device for conducting transactions associated with the account. After registering the secondary computing device for conducting transactions associated with the account, a request to authorize a first transaction is received. The request identifies the secondary computing device, the account, and an amount associated with the first transaction. The account is debited by the amount identified in the request.

Other objects, features, and advantages will be apparent to persons of ordinary skill in the art in view of the following detailed description and the accompanying drawings.

### BRIEF DESCRIPTION OF THE DRAWINGS

For a more complete understanding of the present disclosure, needs satisfied thereby, and the objects, features, and advantages thereof, reference now is made to the following description taken in connection with the accompanying drawings. Embodiments of the present disclosure, and their features and advantages, may be understood by referring to FIGS. 1-5, like numerals being used for corresponding parts in the various drawings.

FIG. 1 illustrates an environment for registering and authorizing secondary devices for conducting transactions, according to a non-limiting embodiment of the present disclosure.

FIG. 2 illustrates server for conducting transactions, according to a non-limiting embodiment of the present disclosure.

FIG. 3 illustrates a flow diagram depicting a process for registering and authorizing secondary devices for conducting transaction, according to a non-limiting embodiment of the present disclosure.

FIG. 4A-J illustrates various graphic user interface screens for registering and authorizing secondary devices for conducting transaction, according to a non-limiting embodiment of the present disclosure.

FIG. 5 illustrates a sequence diagram for conducting a transaction by a secondary device, according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor and/or processing circuitry of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Users of wireless devices such as mobile phones have access to mobile payment applications that may be used to conduct financial transactions without requiring presentation of a credit or debit card. Such applications are downloaded to the mobile phone or other wireless device and typically require registration of at least one credit or debit card. Thereafter, the user of the mobile phone may use the mobile payment application running on the mobile phone to conduct financial transactions. For example, in a brick and mortar store where the merchant has point of sale (POS) equipment that communicate wirelessly with the mobile phone, the POS equipment may communicate with the application to pay for items purchased. Rather, than swipe a credit or debit card through the card reader of the POS equipment, the buyer may hold the buyer's mobile phone near the POS equipment. The POS equipment may then communicate with the mobile phone to wirelessly request and receive credit or debit card information from the mobile payment application.

As another example, these mobile payment applications may be used for paying for online purchases. Specifically, a user completing a financial transaction using the Internet may select to use the application to complete the financial transaction. Payment may then be authorized and received via the application using stored account information rather than requiring the user to enter the credit card number and other information needed for authorizing the financial transaction.

To prevent fraudulent use of credit and debit cards, mobile payment applications that are used in this manner for conducting financial transactions typically will only accept the information associated with a particular credit card from one user. When a user of a mobile computing device downloads the application and registers a credit or debit card for use, a one-time password (OTP) is sent to the user's mobile computing device. The user must enter the OTP on that device to finalize registration of the card. Generally, mobile payment systems only allow a card to be registered one time with the mobile payment system. Accordingly, after a card is registered by a first user, that particular card cannot be registered by another user. If someone tries to register that card for use on another mobile device, the mobile payment system will recognize the credit or debit card as being registered with another account holder and deny registration of the credit or debit card by the second user. As such, all attempts to register a card after the card is registered a first time may be deemed fraudulent by current mobile payment systems.

However, there may be circumstances in which an owner of a credit or debit card (hereinafter, “primary user”) would like to allow other users (hereinafter, “secondary users”) to use the same credit card to conduct financial transactions. For example, a primary card holder may desire to allow a dependent to use a card registered to the primary user to also conduct financial transactions using the mobile payment system. However, as described above, current authentication methods send OTP authorization requests to the same device initiating the registration of the card. While this is permissible in single cardholder transactions, the current evolved market of digital payment systems accommodating secondary cardholders poses some challenges regarding authentication. Specifically, because existing mobile payment systems only allow a credit card number to be registered once, secondary users will be prohibited from using cards that are already registered for use on the primary user's account.

Accordingly, there is a need in the marketplace for mobile payment systems to enable a primary user to authorize secondary users to register a previously registered credit or debit card for use in conducting financial transactions. The present disclosure provides, inter alia, a solution to overcome the weaknesses of traditional mobile payment systems. The present disclosure describes, inter alia, a more secure mobile payment system for registering and authorizing secondary devices for conducting financial transactions at the authorization of a primary user and according to restrictions that the primary user may set. Embodiments of the present disclosure may address the above problems, and other problems, individually and collectively.

Certain embodiments of the present disclosure may provide one or more technical advantages. For example, certain embodiments make it possible to provision a single credit or debit card on multiple devices. As such, a primary user of an account may authorize one or more secondary users to use a credit or debit card with a mobile payment system without increasing vulnerability to the financial account and the potential for fraud.

Certain embodiments ensure that a primary user participates in the authentication of secondary users of secondary computing devices. Stated differently, a primary user is the authentication authority of secondary devices and transactions by secondary devices. As such, a technical advantage may be that authentication information associated with the primary user's account is not shared with other secondary users. Accordingly, security of financial accounts may be enhanced even where time bound sharing of credit and debit cards is allowed.

Another advantage still may be that, rather than rely on the honesty of secondary cardholders to initiate only legitimate transactions, a primary user can place restrictions on the spending or use of the credit or debit card by secondary holders As such, certain embodiments may decrease the risk and possibility of fraud by unauthorized users, as well as prevent misuse by authorized secondary users. Still another advantage may be that certain embodiments ensure that a user can easily block any device that might be compromised or any device that may have been fraudulently used to access the user's account without permission.

Yet another advantage may be that a graphical interface may provide a primary cardholder visibility of all users and devices where a card has been provisioned. As such, a particular advantage may be that a primary account holder can monitor and track all such devices and related financial transactions.

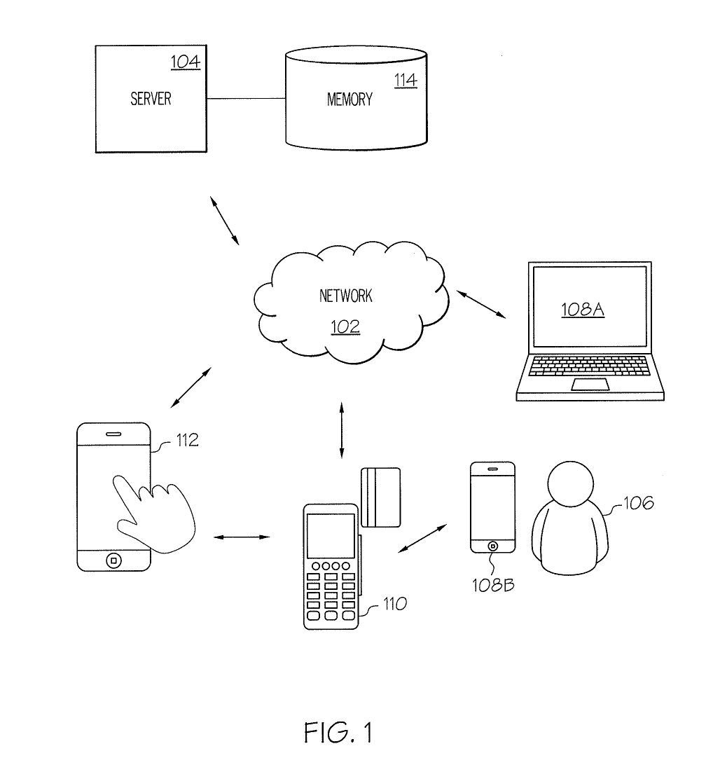

FIG. 1 illustrates an exemplary distributed system 100 in which the subject matter of the disclosure can function. The system 100 generally includes a public network 102 communicatively coupling a server 104 to one or more client devices. In the depicted embodiment, for example, system 100 includes a primary user 106 of one or more primary computing devices 108A-B. A primary user 106 may be a primary card or account holder of a financial account maintained by server 104. As described above, according to certain embodiments, primary user 106 may download a mobile payment application to one or more computing devices 108B associated with primary user 106. Primary user 106 may then provision the mobile payment application with credit or debit card account information. The mobile payment application may then be used by the primary user 106 to complete financial transactions.

According to certain embodiments, primary user 106 may also authorize one or more secondary computing devices 112 associated with one or more secondary users to use the same credit or debit card account information with the mobile payment application. For example, when secondary user downloads the mobile payment application to a secondary computing device 112, the secondary user may be prompted to register credit or debit card information. If the secondary user has the primary user's credit or debit card information, the secondary user may enter the information into the secondary computing device 112 to register the card with the mobile payment systems application stored on the secondary computing device 112. However, if server 102 detects, based on the user account information stored in memory 114, that the credit or debit card is already registered to a device 108A-B associated with primary user 106, server 102 may require authorization from primary user 106 before allowing the secondary user to provision the credit or debit card on the secondary computing device 112.

The network 102 generally refers to any interconnecting system capable of transmitting audio, video, signals, data, messages, or any combination of the preceding. Further, the network 102 may include all, or a portion of a public switched telephone network (PSTN), a public or private network, a local area network (LAN), a metropolitan area network (MAN), a wide area network (WAN), a local, regional, or global communication or computer network such as the Internet, a wired or wireless network, other suitable communication link, or any combination of similar systems.

Primary computing devices 108A-B, secondary computing device 112, and POS equipment 110 may communicate with server 104 via network 102, which may include any number of subnetworks. Network 102 may transmit information in packet flows in one embodiment. A packet flow includes one or more packets sent from a source to a destination. A packet may comprise a bundle of data organized in a specific way for transmission, and a frame may comprise the payload of one or more packets organized in a specific way for transmission. A packet-based communication protocol, such as Internet Protocol (IP), may be used to communicate the packet flows.

A packet flow may be identified in any suitable manner. As an example, a packet flow may be identified by a packet identifier giving the source and destination of the packet flow. A source may be given by an address, such as the IP address, port, or both. Similarly, a destination may be given by an address, such as the IP address, port, or both.

According to certain embodiments, network 102 may utilize protocols and technologies to transmit information. Example protocols and technologies include those described by the Institute of Electrical and Electronics Engineers, Inc. (IEEE) 802.xx standards, such as 802.11, 802.16, or WiMAX standards, the International Telecommunications Union (ITU-T) standards, the European Telecommunications Institute (ETSI) standards, Internet Engineering Task Force (IETF) standards, the third generation partnership project (3GPP) standards, or other standards.

According to certain embodiments, server 104 may include a file server, a domain name server, a proxy server, a web server, a computer workstation, or any other device providing access to enterprise network 110. Further, the server 104 may use any appropriate operating system, such as MS-DOS®, MAC-OS®, WINDOWS®, UNIX®, or any other operating system currently in existence or developed in the future.

According to certain embodiments, server 104 operates as a transaction server and maintains account information in memory 114. The account information may be used in the authorization of primary users and/or secondary users and the completion of financial transactions by such users. According to certain embodiments, memory 114 may include storage media, such as hard disk drives, volatile or non-volatile memory, optical disk storage devices, or any other storage devices, including removable storage devices.

As used here, the term “primary computing device,” “secondary computing device,” “wireless device,” and “computing device” generally refers to any suitable device operable to communicate with the server 104 through the network 102. Primary computing devices 108A-B and secondary computing devices 112 may include, for example, a personal digital assistant, a computer (e.g., a laptop, a desktop workstation, a server, etc.), a cellular phone, a mobile internet device (MID), an ultra-mobile PC (UMPC), or any other device operable to communicate with the server 104 through the network 102. Further, primary computing devices 108A-B and secondary computing devices 112 may employ any known operating systems such as MS-DOS®, PC-DOS®, OS-2®, MAC-OS®, or any other appropriate operating systems.

In particular embodiments of the invention, communications between primary computing devices 108A-B and secondary computing devices 112 and transaction server 104 may be effected according to one or more secure wireless communication protocols or WLAN protocols, such as portions or all of the Wired Equivalent Privacy (WEP) protocol, the Robust Security Network (RSN) associated with the IEEE 802.11 protocol, the IEEE 802.1x protocol, the Advanced Encryption Standard (AED), the Temporal Key Integrity Protocol (TKIP), Extensible Authentication Protocol over LAN (EAPOL) algorithms or protocols (such as EAP-TTLS, PEAP, or CISCO's LEAP or EAP-FAST protocols, for example), WiFi Protected Access (WPA) protocol, WiFi Protected Access Pre-shared key (WPA-PSK) protocol, WiFi Protected Access Version 2 (WPA2) protocol, or WiFi Protected Access Version 2 Pre-shred key (WPA2-PSK) protocol, for example.

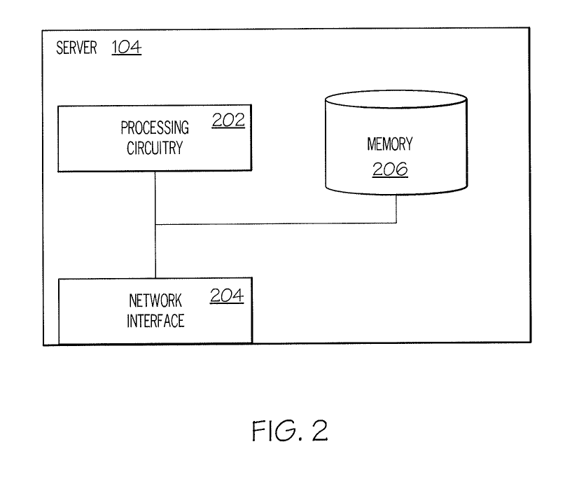

FIG. 2 illustrates a server 104 operating as a transaction server according to a non-limiting embodiment. As depicted, server 104 includes a processing circuitry 202, a network interface 204, and a system memory 206. The network interface 204 connects server 104 to network 102. The processing circuitry 202 may be utilized for the processing requirements of server 104. In certain embodiments, processing circuitry 202 may be operable to load instructions from a hard disk into memory 206 and execute those instructions.

Network interface 204 may refer to any suitable device capable of receiving an input, sending an output from server 104, performing suitable processing of the input or output or both, communicating with other devices, and so on. For example, the network interface 204 may include appropriate modem hardware, network interface card, and similar devices. Further, the software capabilities of the network interface 204 may include protocol conversion and data processing capabilities, to communicate through a LAN, WAN, or other communication system, allowing server 104 to communicate to other devices. Moreover, the network interface 204 may include one or more ports, conversion software, or both.

Processing circuitry 202 can be any suitable device capable of executing instructions to perform operations for server 104. Processing circuitry 202 may include microprocessors, microcomputers, microcontrollers, digital signal processors, central processing units, processing circuitry, state machines, logic circuitries, and/or any devices that manipulate signals based on operational instructions. For example, processing circuitry 202 may be any central processing unit (CPU), such as the Pentium processor, the Intel Centrino processor, and so on.

Further, the system memory 206 may be any suitable device capable of storing computer-readable data and instructions. For example, the system memory 206 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

According to certain embodiments, memory 206 stores account information, which may include any data generated or received for the completion of financial transactions by primary computing devices 108A-B and secondary computing devices 114. For example, account information may include credit or debit card information including account number, expiration dates, security codes, and other suitable information. Additionally, memory 206 may be used to store transaction related information associated with an account. In one example, transaction information may include a list of transactions that have been authorized or denied. Such information may also include merchant identification information, location information, date information, amount information, requesting user information, or other suitable transaction-specific information, according to certain embodiments.

Although server 104 is depicted as including only a single network interface 204, processing circuitry 202, and memory 206, these items may be present in multiple items, or combined items, as known in the art. It is also recognized that other embodiments may include the placement of one or more of these components elsewhere in server 104.

According to certain embodiments, server 104 may provide mobile payment application for provisioning on primary computing devices 108A-B and secondary devices 112. For example and as described above, when setting up the mobile payment application on a primary computing device 108A-B, primary user 106 may first register a credit or debit card for use with the mobile payment application. According to certain embodiments, registering the credit or debit card may include entering the credit or debit card account number, expiration date, security code, and any other information associated with the credit or debit card.

As discussed above, to authenticate and register the account, server 104 may send a one-time password (OTP) to the primary device 108A-B on which the credit or debit card is being registered. For example, if primary user 106 downloads the mobile payment application to computing device 108B, server 104 sends an OTP to computing device 108B. The mobile payment application may then request that primary user 106 enter the OTP into computing device 108B to authenticate primary user 106 and complete the registration of the credit or debit card for use with the mobile payment systems application.

As described above, in certain embodiments, primary user 106 may wish to authorize a secondary user of a secondary computing device 112 to also use the same credit or debit card information for conducting financial transactions with the mobile payment application. For example, in a particular embodiment, primary user 106 may be a parent of a dependent child or adult and may wish to allow the dependent to use the primary user's credit or debit card under some or all circumstances. If the dependent (i.e., secondary user) downloads the mobile payment application to a secondary computing device 112, the dependent will then be prompted to register a credit or debit card. However, since the credit or debit card information has already been registered primary user 106 and is stored in memory 206 or memory 114, server 104 will not allow registration of the credit or debit card on the secondary computing device 112 without receiving authorization from primary user 106.

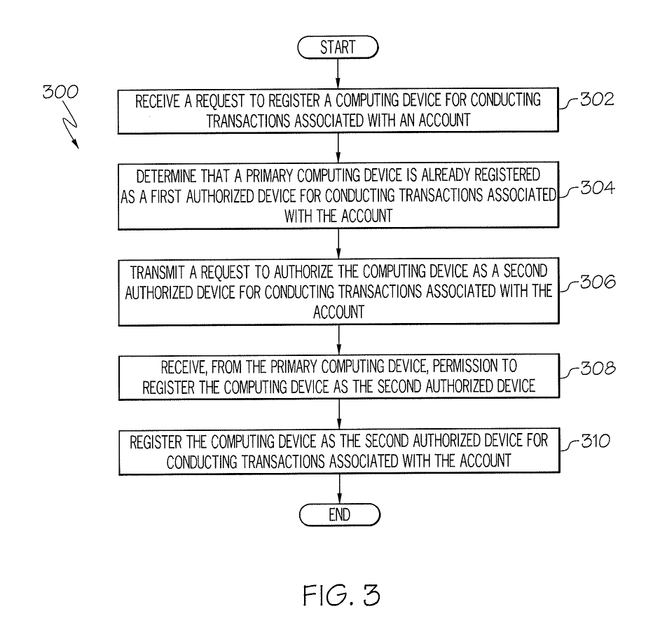

FIG. 3 a flow diagram depicting a process 300 by server 104 for registering a credit or debit card associated with a primary user and device for use with a secondary computing device 112, according to a non-limiting embodiment of the present disclosure. As depicted, the method begins at step 302 when a request is received from secondary computing device 112. In a particular embodiment, for example, the request may include credit or debit card information such as an account number, an expiration date, a security code, or other account identifying information.

At step 304, server 104 determines that a primary computing device 108A-B is already registered as a first authorized computing device for conducting transactions associated with the account. According to a particular embodiment, a financial transaction may be conducted for a nominal amount as a preliminary authorization of the secondary computing device. For example, in a particular embodiment, the primary user's credit or debit card account may be debited by a dollar.

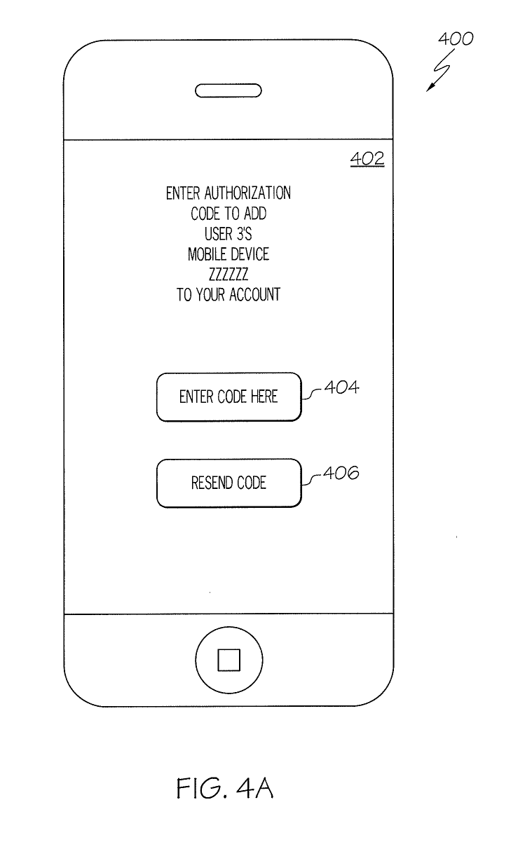

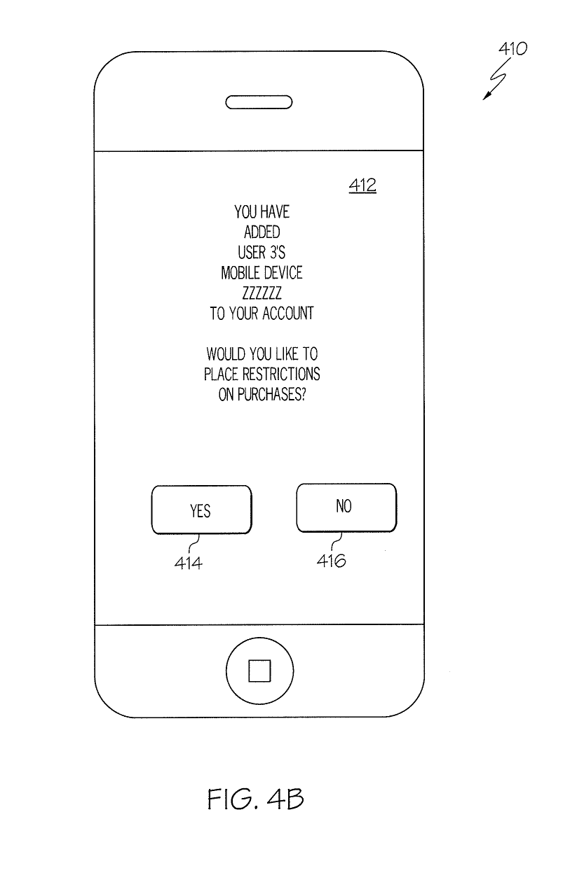

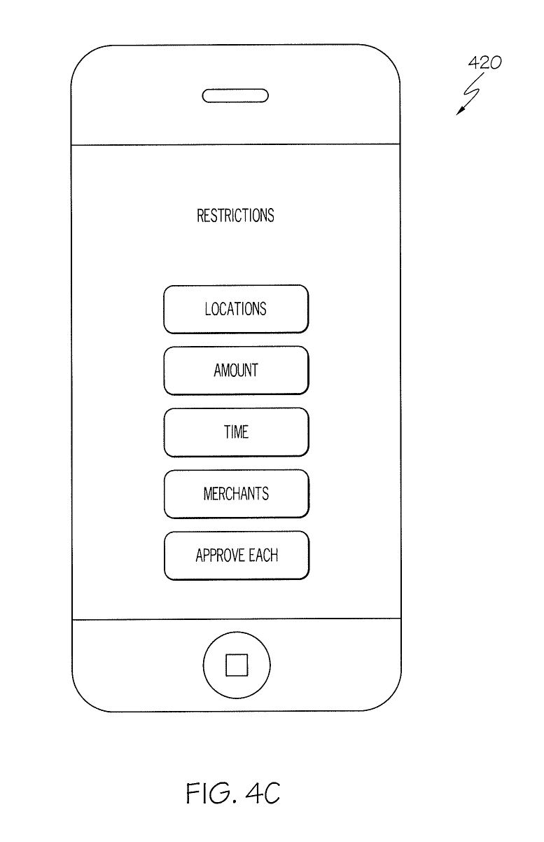

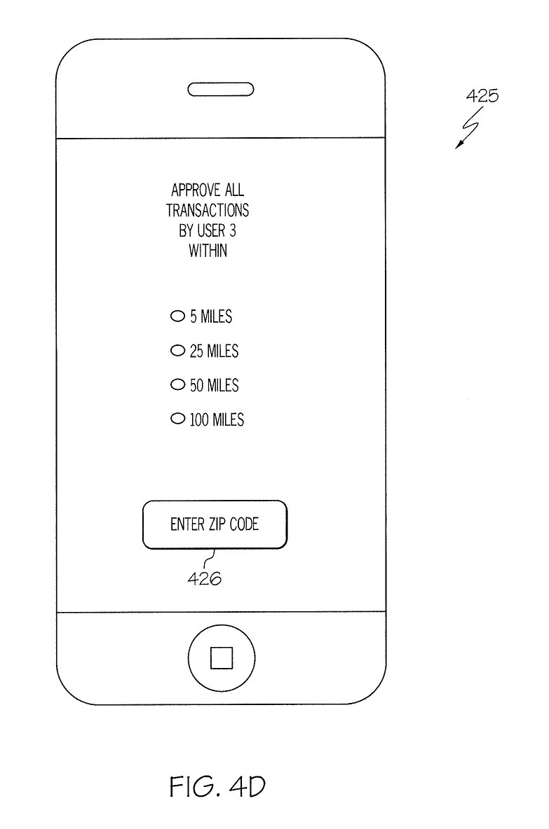

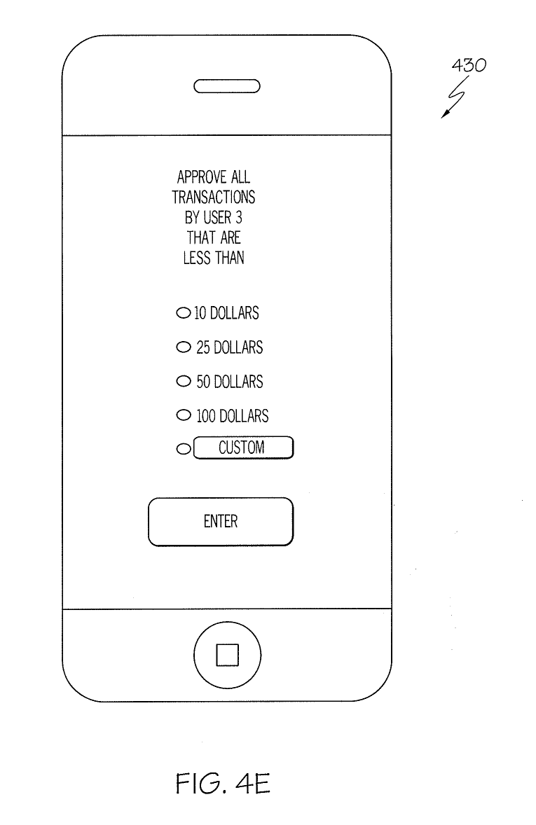

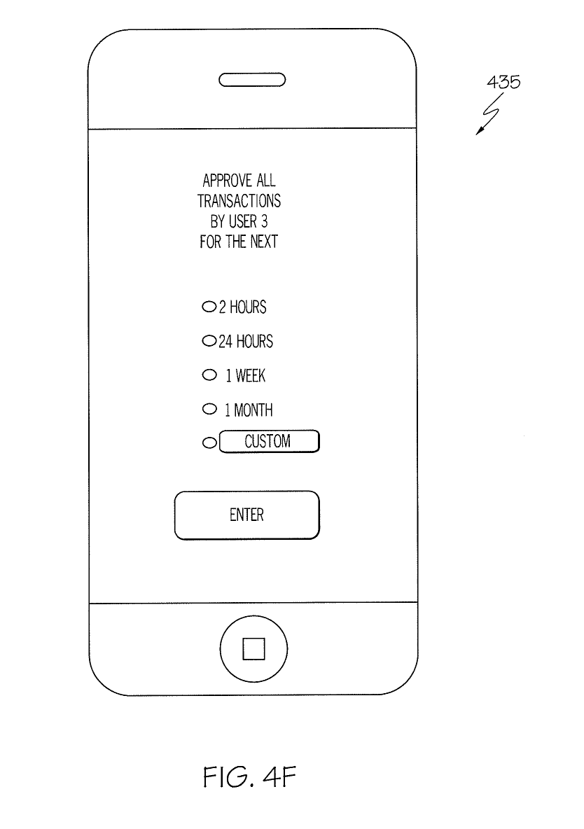

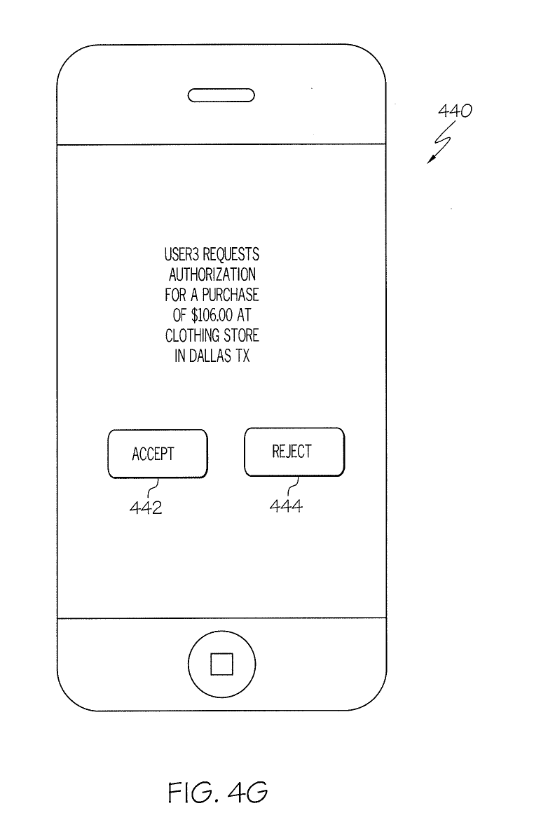

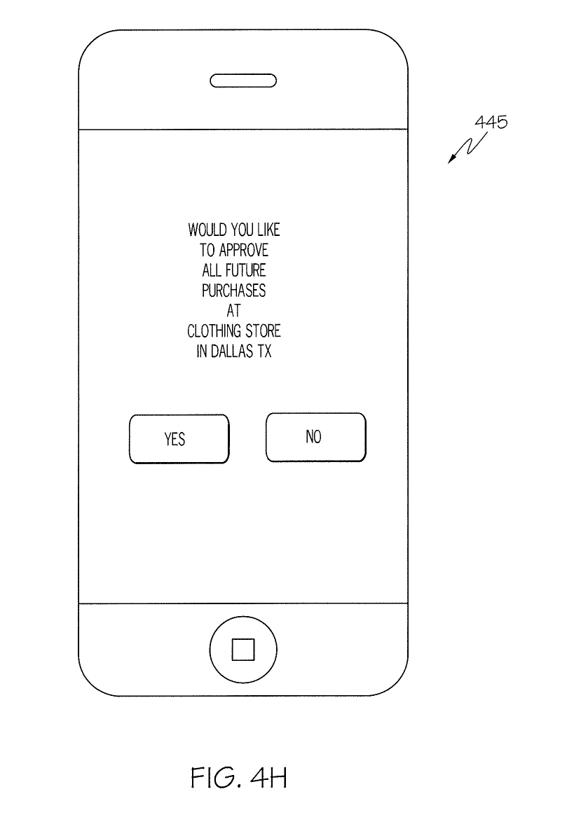

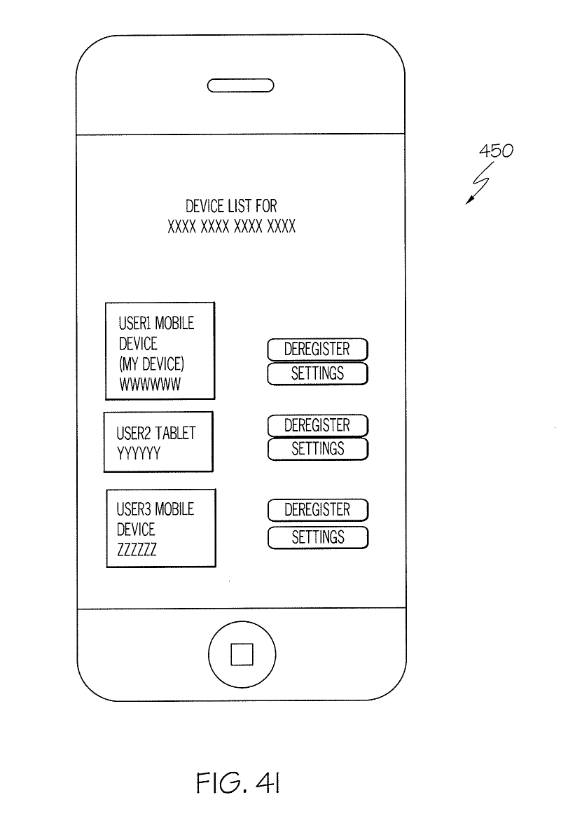

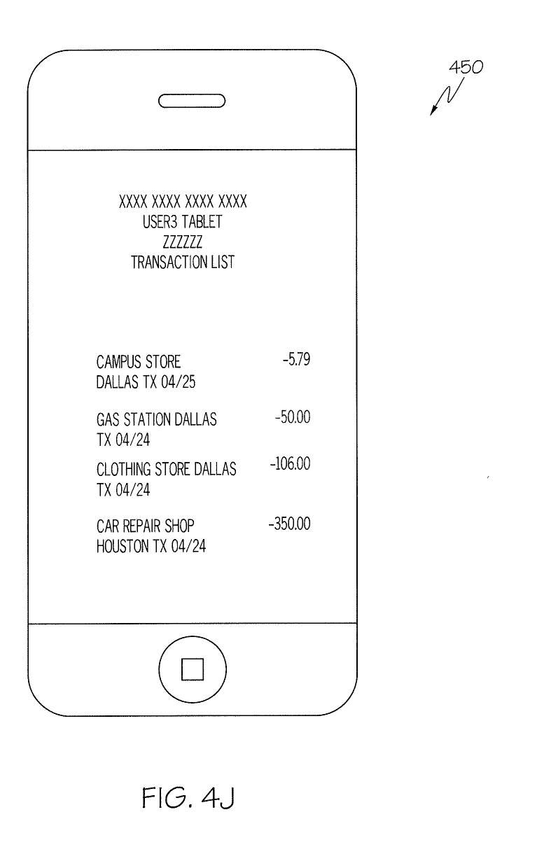

Before or after preliminary authorization is performed, server 104 may transmit a request, to the primary computing device 108A-B, to authorize the secondary computing device as a second authorized device for conducting transactions associated with the account, at step 306. For example, server 104 may send an authorization request to the primary user's mobile phone, in a particular embodiment. An example graphic user interface screen 400 including such an authorization request 402 is depicted in FIG. 4A.

According to certain embodiments, authorization request 402 may comprise a pop-up notification that appears on the screen of one or more primary computing devices 108A-B. As depicted, authorization request 402 includes text requesting primary user 106 to enter an authorization code to add the secondary user of secondary device 112 to the primary user's account and, thus, allowing secondary device 112 to be used to conduct financial transactions using the primary user's credit or debit card. In a particular embodiment, the authorization code includes an OTP that is also provided to primary computing device 108A-B. The OTP may be provided on graphic user interface screen 400 or may be provided as a separate pop-up that appears on the screen of primary computing device 108A-B separately from authorization request 402. In the depicted embodiment, primary user 106 may enter the authorization code in the field 404, which is depicted with the label ‘Enter Code Here’. If the primary user 106 didn't receive or didn't see the authorization code, button 406 may be selected to request that the authorization code be resent to primary computing device 108A-B.

As depicted, graphic user interface screen 400 identifies secondary user as ‘User 3.’ However, it is generally recognized that ‘User 3’ is a generic placeholder that may be replaced with a name or other information that identifies the secondary user of secondary device 112 to primary user 106. Likewise, graphic user interface screen 400 identifies the particular secondary device 112 as a ‘Mobile Device’ to indicate to primary user 106 the particular type of device seeking access to the primary user's account. The term ‘Mobile Device’ may be replaced with ‘Mobile Phone’, ‘Tablet,’ ‘PC,’ ‘Mac,’ or any other suitable term for identifying the type of device seeking to register the credit or debit card. Alternatively, such information may be omitted, in certain particular embodiments.

Returning to FIG. 3, the method continues at step 308 when server 104 receives, from primary computing device 108A-B, permission to register secondary computing device 112 as the second authorized device. As described above, the permission may be received as the OTP entered into the primary computing device 108A-B by primary user 106, according to a particular embodiment. At step 310, server 104 then registers secondary computing device 112 to conduct transactions associated with the account.

According to certain embodiments, the method may also allow primary user 106 to place various restrictions on use of the credit or debit card by the secondary user of secondary computing device 112. FIGS. 4B-4J depict various graphic user interface screens that may be presented to primary user 106 after registration of secondary computing device 112. For example, FIG. 4B depicts a graphic user interface screen 410 that provides a confirmation message 412 summarizing the registration of secondary computing device 112 as an authorized secondary device. The confirmation message 412 also includes text asking if the primary user 106 would like to place restrictions on purchases by the secondary user of secondary computing device 112. Primary user 106 may press the ‘Yes’ button 414 if such restrictions are desired or the ‘No’ button 416 if such restrictions are not desired.

FIG. 4C illustrates an example graphic user interface screen 420 providing various restriction options to a primary user 106, according to one non-limiting embodiment. In the depicted example, a primary user 106 may select any of the provided buttons to place desired location, amount, time, merchant, or other restrictions on the ability of the secondary user of secondary computing device 112 to use the primary user's credit or debit card information. If a primary user 106 places restrictions on the secondary user of the authorized secondary computing device 112, server 104 may apply one or more rules to transaction requests to determine whether to authorize the transactions requested by the secondary user. Only those transactions with the confines of the parameters set by the primary user 106 will be approved. Alternatively, if the primary user 106 desires to review each transaction to manually determine whether each transaction is approved or denied, the primary user 106 may select the ‘Approve Each’ button on graphic user interface screen 420.

FIG. 4D illustrates an example graphic user interface screen 425 which allows primary user 106 to enter certain location-based restrictions on secondary computing device 112. Specifically, graphic user interface screen 430 enables primary user 106 to restrict secondary computing device 112 to conducting only financial transactions that occur within a distance of a user-provided zip code. For example, primary user 106 may select to authorize only transactions that occur within a 25 mile radius of a zip code entered into field 426.

FIG. 4E illustrates an example graphic user interface screen 430 which allows primary user 106 to enter certain amount-based restrictions on secondary computing device 112. Specifically, graphic user interface screen 430 enables primary user 106 to restrict secondary computing device 112 to conducting financial transactions that are less than a user-provided amount. In the particular embodiment depicted, for example, primary user 106 may select to authorize all transactions that are less than ten, twenty-five, fifty, one-hundred, or a custom amount.

FIG. 4F illustrates an example graphic user interface screen 435 which allows primary user 106 to enter certain temporal-based restrictions on secondary computing device 112. Specifically, graphic user interface screen 435 enables primary user 106 to restrict secondary computing device 112 to conducting financial transactions that occur within a user-provided amount of time. In the particular embodiment depicted, for example, primary user 106 may select to authorize all transactions that occur within the next two hours. Alternatively, the primary user 106 may authorize transactions for a day, a week, a month, or a custom amount of time.

FIG. 4G illustrates an example graphic user interface screen 440 that provides notification and requests authorization of a pending financial transaction. This or a similar graphic user interface screen may pop-up on the primary user's computing device 108A-B when the secondary user of secondary computing device 112 has requested a purchase that violates a restriction places on purchases by the primary user 106 or when primary user 106 has requested to individually approve all transactions. In the depicted example, graphic user interface screen 440 notifies primary user 106 that the secondary user of secondary computing device 112 is requesting approval of a purchase at Clothing Store in Dallas, Tex. for an amount of $106. Primary user 106 may select the ‘Accept’ button 442 to approve the transaction or the ‘Reject’ button 444 to reject the request.

FIG. 4I illustrates an example graphic user interface screen 445 which allows primary user 106 to approve all future purchases similar to an approved purchase. For example, if primary user 106 selected to approve the purchase depicted in FIG. 4H, graphic user interface screen 445 might popup to allow primary user 106 to approve all future purchases at Clothing Store in Dallas, Tex. Thereafter, and depending the on the settings of primary user 106, primary user 106 might not receive notifications of future purchases at Clothing Store in Dallas, Tex. Alternatively, primary user 106 might receive notifications of such purchases before or after such purchases are approved automatically by server 104.

According to certain other embodiments, server 104 may intelligently modify the restrictions and risk parameters associated with a primary user's account based on prior authorizations of transactions by primary user 106. For example, if primary user 106 approves a particular financial transaction, server 104 may identify characteristics associated with that transaction which are deemed permissible. In a particular embodiment, for example, server 104 may determine that the purchase of a particular item from a particular store has been authorized. Thereafter, server 104 may not seek authorization from primary user 106 for subsequent requests for purchases for the same item from the same store by a secondary computing device 112. As such, in a particular embodiment, server 104 may modify the rules applied to transaction based on the shopping trends of authorized users and previously authorized transactions. Conversely, where authorization for a purchase is requested by a secondary computing device 112 at a new merchant, new location, or for a new item, an authorization request may be transmitted to primary user 106 prior to authorizing the financial transaction.

According to certain embodiments, merchants and locations may be grouped into certain domains such that all transactions within a particular domain are treated similarly. For example, primary user 106 may be presented with a list of transaction types, such as educational, retail, grocery, casino, household, etc. Using the settings within mobile payment systems application, primary user 106 may deem transactions within each domain or transaction type to be approved or denied on a global basis. For example, if the primary user 106, as the parent of a dependent, wishes to authorize all educational purchases at a campus bookstore by the dependent secondary user, the primary user 106 may set a rule to enable server 104 to automatically authorize all purchases from merchants deemed by server 104 to be educational in nature. Additionally restrictions could be applied to further restrict authorization of transactions. For example, a rule could be set to automatically authorize all purchases within a 1 mile radius of a university campus, in a particular embodiment.

According to certain embodiments, rules may be set or automatically generated in a similar manner to deny certain domains or types of transactions. For example, a primary user 106 may wish to deny all financial transactions related to gambling. As such, primary user 106 may set or put into effect a rule which causes server 104 to automatically deny any financial transactions originating from a merchant within the gambling domain. As such, any transaction at a casino might be automatically denied. Alternatively, primary user 106 may set or put into effect a rule which causes server 104 to seek manual authorization by primary user 106 of such transactions. Thus, while such transactions might not be automatically denied, server 104 may send primary user 106 an authorization request for each requested transaction that is deemed to be related to gambling or another restricted domain, according to particular embodiments.

FIG. 4I illustrates an example graphic user interface screen 450 which provides primary user 106 with a list of devices on which a particular credit or debit card is provisioned. According to certain embodiments, at any time, primary user 106 may log into the mobile payment systems application to view activity on the primary user's account. One example view that may be provided to primary user 106 may be a list of devices authorized to use the primary user's credit or debit card information.

In the depicted example embodiment, graphic user interface screen 450 lists all or a portion of the particular credit or debit card associated with the account. However, for security purposes, a portion of the credit or debit card may be masked, according to a particular embodiment.

Additionally, graphic user interface screen 450 provides a listing of each computing device authorized to use the particular credit or debit card. According to certain embodiments, the list may include certain information associated with each computing device. For example, in a particular embodiment, information such as each user's name and the type of device on which the credit or debit card is provisioned may be provided. Additionally, a device serial number or another device-specific identifier may be provided. According to a particular embodiment, an application identifier may additionally or alternatively be provided. The application identifier may include a unique identifier generated by the mobile payment application or by server 104 during provisioning of a credit or debit card using the mobile payment application.

For each device, primary user 106 may be given the option to “Deregister” the particular device. For example, if primary user 106 gets a new mobile phone or if the mobile phone is lost or stolen, primary user may wish to deregister the primary user's own Mobile Device and add a new mobile device as the primary device. As another example, if at any time, primary user 106 desires to remove a secondary computing device 112 from the primary user's account, primary user 106 may deregister that device from the account. For example, if primary user only wished to share his credit or debit card with the secondary user for a limited amount of time, primary user 106 may deregister the secondary computing device after the given amount of time. Alternatively, if the secondary user has registered the credit or debit card fraudulently or has requested transactions in violation of the primary user's wishes, primary user 106 may deregister the secondary computing device 112.

In a particular embodiment, after deregistration, the next time a the secondary computing device 112 opens the mobile payment application or the next time the mobile payment application automatically updates, the information associated with the primary user's account may be deleted. Thereafter, the primary users' credit or debit card would not available for use in conducting financial transactions by the secondary computing device 112.

In the depicted example embodiment, a ‘Settings’ button is provided for each registered device. Primary user 106 may select the ‘Settings’ button for any one particular device to view and or edit the restrictions applied to that device. As another example, primary user may select the ‘Settings’ button to change the notifications settings for transactions conducted by a particular device.

Though graphic user interface screen 450 is depicted as being particular to one credit or debit card, it is recognized that multiple credit or debit cards could be associated with the account of a primary user 106. A similar view like graphic user interface screen 450 may be provided for each credit or debit card. Alternatively, a single graphic user interface screen may be used to summarize all authorized devices for all registered credit or debit cards associated with the account.

According to certain embodiments, the information depicted in graphic user interface screen 450 may only be accessed or viewed by primary user 106. In a particular embodiment, for example, the first user to download the mobile payment application and register a credit or debit card may be deemed the primary user 106 of that credit or debit card. Primary user 106 may then be allowed to view and alter settings for using that credit or debit card. Secondary users of secondary computing devices 112 that subsequently register the same credit or debit card may not be given full access to account information or the ability to view and alter settings. As such, secondary computing devices 112 may only have limited access to the mobile payment systems application or may only be able to download a secondary version of the mobile payment application.

Though the graphic user interface screen 450 is depicted as being shown on the mobile computing device 108B of primary user 106 using the mobile payment systems application, a similar view may be provided of this graphic user interface screen or any other described graphic user interface screen in a web-based version that may be accessed via the Internet by computing device 108A or another such computing device. For example, in a particular embodiment, primary user 106 may login to the website using appropriate authentication credentials. The primary user 106 may then view the list of devices registered to the primary user's account through a browser plugin. According to a particular embodiment, the browser plugin may also be used to determine the particular information to be displayed to primary user 106. For example, the browser plugin may pick a particular credit or debit card number and display only the devices authorized by primary user 106 for using that credit or debit card number.

FIG. 4J illustrates an example graphic user interface screen 460 which allows primary user 106 to view and monitor all transactions associated with a particular credit card associated with the primary user's account. As depicted, each transaction is listed in chronological order with the most recent transaction listed first. Each transaction listed includes information identifying the merchant, the location, the date, the user, the device, and the amount associated with the transaction. For example, the first listed transaction is for a purchase by User 1 at Grocery Store in Dallas, Tex. on April 26th. The device or application generated identifier is depicted as “wwwww”, and the amount of the transaction was $32.46. Though not depicted, in a particular embodiment, a balance or other total for the account may also be provided.

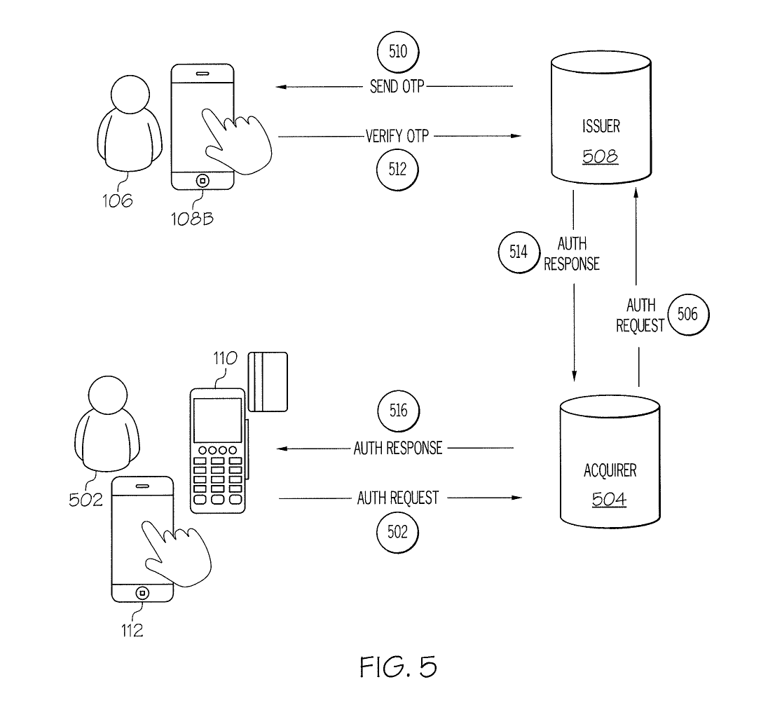

According to certain embodiments described above, primary user 106 may exercise control over some or all of the financial transactions conducted by a secondary user of a secondary computing device 112. For example, primary user 106 may be required to approve a first transaction by a secondary computing device 112 before the financial transaction is allowed. As another example, primary user 106 may have placed restrictions on use by the secondary computing device 112, and primary user 106 may be required to authorize any financial transactions that do not fall within the parameters allowed by the primary user 106. Stated differently, where restrictions have been applied and a financial transaction may not be automatically allowed by server 104, primary user 106 may be given the opportunity to approve the transaction manually. FIG. 5 illustrates a sequence diagram for conducting a transaction by a secondary device 112 that requires authorization by a primary user 106 of primary computing device 108A-B, according to one non-limiting embodiment. As depicted, secondary device 112 is shown as being operated by a secondary user 502, which may be a dependent of primary user 106, according to a particular embodiment.

In an example scenario, secondary user 502 may hold secondary computing device 112 proximate to POS equipment 110 during the payment phase of a financial transaction at a brick and mortar store. The secondary computing device 112 and POS equipment 110 may wirelessly communicate such that POS equipment 110 receives payment information from mobile payment systems application. The payment information may include credit or debit card information associated with primary user's 106 account.

At step 502, the payment information is included in an authorization request which is transmitted from POS equipment 110 to an acquirer banking institution 504. At step 506, the authorization request is then forwarded to an issuer banking institution 508.

To authorization the transaction, issuer banking institution 508 sends an OTP request to primary computing device 108B of primary user 106, at step 510. As discussed above, the OTP request may be included in a popup notification, according to a particular embodiment. Additionally, according to a particular embodiment, the OTP request may include certain transaction specific information to better enable primary user 106 to determine whether to deny or reject the financial transaction request. In a particular embodiment, for example, the OTP request may include information related to the identity of secondary user 502, the identity of the merchant associated with POS equipment 110, the amount of the financial transaction requested, and/or any other suitable information.

If primary user 106 wishes to authorize the financial transaction, primary user 106 may enter the OTP into primary computing device 108B. The OTP may be sent to issuer banking institution 508 at step 512. Issuer bank 508 may then send an authorization response to acquirer banking institution at step 514. Acquirer bank may forward the authorization response or another authorization message to POS equipment 110 to finalize the financial transaction, at step 516.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It will also be understood by those of ordinary skill in the art that the scope of the disclosure is not limited to use in a server diagnostic context, but rather that embodiments of the invention may be used in any transaction having a need to monitor information of any type. The specification and the described examples are considered as exemplary only, with the true scope and spirit of the invention indicated by the following claims.

What is claimed is:

1. A method by a server, the method comprising:
receiving, by the server, a request to register a computing device for conducting transactions associated with an account;
determining, by the server, that a primary computing device is already registered as a first authorized device for conducting transactions associated with the account;
transmitting, to the primary computing device, a request to authorize the computing device as a second authorized device for conducting transactions associated with the account;
receiving, from the primary computing device, permission to register the computing device as the second authorized device; and
registering the computing device as the second authorized device for conducting transactions associated with the account.

2. The method of claim 1, wherein:
transmitting the authorization request to the primary computing device comprises transmitting a one-time password to an email address associated with a primary user associated with the primary computing device; and
receiving the permission to register the computing device as the second authorized device comprises receiving the one-time password from the primary user.

3. The method of claim 2, wherein:
the primary computing device comprises a mobile computing device, and
receiving the one-time password from the primary user comprises receiving the one-time password from an application running on the mobile computing device.

4. The method of claim 1, wherein:
the primary computing device comprises a mobile computing device,
transmitting the authorization request to the primary user comprises transmitting a one-time password in a SMS message to the mobile computing device; and
receiving the permission to register the computing device as the second authorized device comprises receiving the one-time password from an application running on the mobile computing device.

5. The method of claim 1, wherein the request to register the computing device is received from an application running on the computing device.

6. The method of claim 1, further comprising:
in response to receiving the request to register the computing device, debiting the account by a nominal amount.

7. The method of claim 1, further comprising:
transmitting, to the computing device, authorization to conduct transactions associated with the account.

8. The method of claim 1, further comprising:
receiving a request to authorize a first transaction, the request identifying the computing device, the account, and an amount associated with the first transaction;
determining that the computing device is authorized to conduct the first transaction; and
debiting the account by the amount identified in the request, and
wherein determining that the computing device is authorized to conduct the first transaction comprises determining that the computing device is registered to conduct transactions associated with the account.

9. The method of claim 8, wherein determining that the computing device is authorized to conduct the first transaction further comprises:
determining that at least one condition is fulfilled.

10. The method of claim 9, wherein the condition is selected from the group consisting of:
the first transaction is associated with a merchant on an approved list of merchants;
the amount identified in the request is less than a maximum threshold amount that is automatically authorized for the computing device;
a current location associated with the computing device is less than a threshold distance from an approved location;
a time stamp associated with the request to authorize the first transaction is within a predefined window of time in which the computing device is authorized to conduct transactions.

11. The method of claim 9, wherein the at least one condition comprises determining that the first transaction has at least one characteristic in common with a previously approved transaction associated with the computing device.

12. The method of claim 9, wherein determining that the computing device is authorized to conduct the first transaction further comprises:
determining that the first transaction is associated with a merchant that is a new merchant with respect to the account;
transmitting an authorization request to the primary computing device for approval of the first transaction; and
receiving authorization from the primary computing device for the first transaction associated with the new merchant.

13. A non-transitory, computer-readable storage medium having instructions stored thereon, the instructions being executable by a computing system to cause the computing system to:
receive a request to register a mobile computing device for conducting transactions associated with an account;
determining that a primary mobile computing device is already registered as a first authorized device for conducting transactions associated with the account;
transmitting, to the primary mobile computing device, a request to authorize the mobile computing device as a second authorized device for conducting transactions associated with the account;
receiving, from the primary mobile computing device, permission to register the mobile computing device as the second authorized device;
registering the mobile computing device as the second authorized device for conducting transactions associated with the account.

14. The non-transitory, computer-readable storage medium of claim 13, wherein:
transmitting the authorization request to the primary mobile computing device comprises transmitting:
an email comprising a one-time password to an account associated with a primary user associated with the primary mobile computing device; or
a SMS message comprising the one-time password to the primary computing device; and
receiving the permission to register the mobile computing device as the second authorized device comprises receiving the one-time password from the primary user.

15. The non-transitory, computer-readable storage medium of claim 13, wherein the instructions are further executable by the computing system to cause the computing system to:
transmit, to the mobile computing device, authorization to conduct transactions associated with the account.

16. The non-transitory, computer-readable storage medium of claim 13, wherein the instructions are further executable by the computing system to cause the computing system to:
receive a request to authorize a first transaction, the request identifying the mobile computing device, the account, and an amount associated with the first transaction;
determine that the mobile computing device is authorized to conduct the first transaction; and
debit the account by the amount identified in the request, and
wherein determining that the mobile computing device is authorized to conduct the first transaction comprises determining that the mobile computing device is registered to conduct transactions associated with the account.

17. The non-transitory, computer-readable storage medium of claim 16, wherein determining that the mobile computing device is authorized to conduct the first transaction further comprises:
determining that at least one condition is fulfilled.

18. The non-transitory, computer-readable storage medium of claim 17, wherein the condition is selected from the group consisting of:
the first transaction is associated with a merchant on an approved list of merchants;
the amount identified in the request is less than a maximum threshold amount that is automatically authorized for the mobile computing device;
a current location associated with the mobile computing device is less than a threshold distance from an approved location; and
a time stamp associated with the request to authorize the first transaction is within a predefined window of time in which the mobile computing device is authorized to conduct transactions.

19. The non-transitory, computer-readable storage medium of claim 17, wherein:
determining that the at least one condition is fulfilled comprises determining that the first transaction has at least one characteristic in common with a previously approved transaction associated with the mobile computing device; and
determining that the mobile computing device is authorized to conduct the first transaction further comprises:
determining that the first transaction is associated with a merchant that is a new merchant with respect to the account;
transmitting an authorization request to the primary mobile computing device for approval of the first transaction; and
receiving authorization from the primary mobile computing device for the first transaction associated with the new merchant.

20. A server comprising:
a memory storing account information for a plurality of accounts; and
processing circuitry with access to the memory, the processing circuitry configured to:
receive a request to register a secondary computing device for conducting transactions associated with an account;
determine that a primary computing device is already registered as a first authorized device for conducting transactions associated with the account;
transmit, to the primary computing device, a request to authorize the secondary computing device as a second authorized device for conducting transactions associated with the account;
receive, from the primary computing device, permission to register the secondary computing device as the second authorized device;
register the secondary computing device as the second authorized device for conducting transactions associated with the account;
after registering the secondary computing device for conducting transactions associated with the account, receive a request to authorize a first transaction, the request identifying the secondary computing device, the account, and an amount associated with the first transaction; and
debit the account by the amount identified in the request.
